(19) United States
(12) Patent Application Publication
(10) Pub. No.: US 2025/0240858 A1
(43) Pub. Date: Jul. 24, 2025

(54) INFRARED / ULTRAVIOLET STROBE DEVICE

(71) Applicant: Avid Labs, LLC, Fort Wayne, IN (US)

(72) Inventors: Joel A. Nichols, Columbia City, IN (US); Jace Andrew Nichols, Fort Wayne, IN (US)

(73) Assignee: Avid Labs, LLC, Fort Wayne, IN (US)

(21) Appl. No.: 19/175,596

(22) Filed: Apr. 10, 2025

Related U.S. Application Data
(63) Continuation-in-part of application No. 18/354,088, filed on Jul. 18, 2023, now Pat. No. 12,305,818.
Application No. 18/354,088 is a continuation-in-part of application No. 18/169,411, filed on Feb. 15, 2023, now Pat. No. 12,281,773.
Application No. 18/169,411 is a continuation-in-part of application No. 17/818,092, filed on Aug. 8, 2022, now Pat. No. 12,108,509.
Application No. 17/818,092 is a continuation-in-part of application No. 17/475,218, filed on Sep. 14, 2021, now Pat. No. 11,466,833.
Application No. 17/475,218 is a continuation-in-part of application No. 17/111,605, filed on Dec. 4, 2020, now abandoned.
Application No. 17/475,218 is a continuation-in-part of application No. 17/076,738, filed on Oct. 21, 2020, now Pat. No. 11,457,517.
Application No. 17/818,092 is a continuation-in-part of application No. 17/076,738, filed on Oct. 21, 2020, now Pat. No. 11,457,517.
(60) Provisional application No. 63/691,857, filed on Sep. 6, 2024.
(60) Provisional application No. 63/498,286, filed on Apr. 26, 2023.
(60) Provisional application No. 62/943,560, filed on Dec. 4, 2019.
(60) Provisional application No. 62/924,363, filed on Oct. 22, 2019.

(51) Int. Cl. H05B 47/155; B64D 47/06; H05B 45/20; H05B 47/16; H05B 47/17

(52) U.S. Cl. CPC H05B 47/155; B64D 47/06; H05B 45/20; H05B 47/16; H05B 47/17

(57) ABSTRACT

An ultraviolet strobe system for an aircraft having an infrared strobe system and a night vision device includes an ultraviolet strobe device and a controller. The controller causes the ultraviolet strobe device to coordinate with the infrared strobe system to alternate between ultraviolet and infrared strobing. The ultraviolet strobe device causes phosphorescent markers affixed to other aircraft to phosphor in response to the strobe pulses, possibly in a wavelength that is visible using the night vision device. The controller illuminates the ultraviolet strobe just long enough for the human eye to register the illumination.

### CROSS REFERENCE TO RELATED APPLICATIONS

This is a Continuation-In-Part claiming priority to U.S. non-provisional application Ser. No. 18/354,088 entitled “LIGHTING SYSTEM”, filed Jul. 18, 2023, which is a Continuation-In-Part claiming priority to U.S. non-provisional application Ser. No. 18/169,411 entitled “LIGHTING SYSTEM”, filed Feb. 15, 2023, which is a Continuation-In-Part claiming priority to U.S. non-provisional application Ser. No. 17/818,092 entitled “LIGHTING SYSTEM”, filed Aug. 8, 2022, which is a Continuation-In-Part claiming priority to U.S. non-provisional application Ser. No. 17/475,218 entitled “LIGHTING SYSTEM”, filed Sep. 14, 2021, which is a Continuation-In-Part claiming priority to U.S. non-provisional application Ser. No. 17/111,605 entitled “LIGHTING SYSTEM”, filed Dec. 4, 2020, which is based upon U.S. provisional patent application Ser. No. 62/943,560, entitled “LIGHTING SYSTEM”, filed Dec. 4, 2019. U.S. non-provisional application Ser. No. 17/475,218 also claims priority to U.S. non-provisional application Ser. No. 17/076,738 entitled “LIGHTING SYSTEM”, filed Oct. 21, 2020, which is based on U.S. provisional patent application Ser. No. 62/924,363 entitled “LIGHTING SYSTEM”, filed Oct. 22, 2019. U.S. non-provisional application Ser. No. 17/818,092 also claims priority directly to U.S. non-provisional application Ser. No. 17/076,738. U.S. non-provisional application Ser. No. 18/354,088 also claims priority to U.S. provisional patent application Ser. No. 63/498,286 entitled “ULTRAVIOLET LED STROBE CONTROLLED BY A MICROCONTROLLER AND CONSTANT CURRENT POWER SUPPLY.” The present application also claims priority to U.S. provisional patent application Ser. No. 63/691,857 entitled “INFRARED/ULTRAVIOLET STROBE DEVICE.” Each of the above-listed applications are incorporated herein by reference.

### FIELD OF INVENTION

This disclosure relates generally to an infrared/ultraviolet strobe device for aircraft. More specifically, it relates to an infrared/ultraviolet strobe device for aircraft used in military applications wherein it is necessary to minimize visibility of an aircraft or a group of aircraft over a possibly hostile environment.

### BACKGROUND

Infrared (IR) light is electromagnetic radiation (EMR) with wavelengths longer than that of visible light but shorter than microwaves. The IR spectral band begins with waves that are just longer than those of red light (the longest waves in the visible spectrum), so IR is invisible to the human eye. IR is generally understood to include wavelengths from around 750 nm (400 THz) to 1 mm (300 GHz).¹

Present military technology used on combat aircraft often includes one or more strobe lights that only use IR light in order to create a strobing effect that is outside of the visible spectrum and that is only visible using night vision equipment. Specifically, during night operation aviation crews of military aircraft operating in a potentially hostile environment often use night vision goggles while turning off all lights on the aircraft except the IR strobes which are not visible without night vision equipment. These strobes allow them to see each other using the night vision equipment and to fly in formation with other aircraft while remaining unseen by personnel on the ground. Further, such IR strobes used by military may utilize IR characterized by a very tight bandwidth, in order to be recognizable only by specific night vision equipment.

Moreover, combat aircraft may be provided with “formation lights,” which may be Light Emitting Diodes (LEDs), and which may be located at three key visual points, for example along the side of the aircraft. These may be very weak green LEDs that further assist pilots in flying their aircraft in formation. Despite being only weakly illuminated, these LEDs may somewhat compromise the invisibility of the aircraft being flown in an otherwise dark condition. ¹ Infrared. 27 Aug. 2024. Retrieved 29 Aug. 2024. https://en. wikipedia.org/wiki/infrared.

Individual hand carried IR strobes similar to those used on combat aircraft that are visible only using the night vision equipment may be used by personnel on the ground. For example, such individual hand carried IR strobes may be used to provide targets for aircraft pilots to utilize during takeoff and/or landing. As another example, such individual hand carried IR strobes may be used to locate troops needing to be picked up or rescued. While the IR strobes attached to the combat aircraft may be effective when used in conjunction with the night vision equipment in order to help the pilots locate the other combat aircraft, the individual hand carried IR strobes may not only be cumbersome to carry but may also be of limited effectiveness in illuminating airstrips, personnel, and equipment on the ground.

Combat aircraft flying in blackout configuration after dark or at dusk may also encounter an increased number of bird strikes versus an aircraft that is fully illuminated. A bird strike, sometimes called bird ingestion (for an engine), bird hit, or bird aircraft strike hazard (BASH) is a collision between an airborne animal, usually a bird or bat, and a moving vehicle, usually an aircraft. A significant threat to flight safety, bird strikes have caused a number of accidents with human casualties. Most accidents occur when a bird or group of birds collides with the windscreen or is sucked into the engine of jet aircraft.²

What is needed in the art is a visual system that better assists pilots in flying their aircraft in formation and in locating other aircraft under blackout conditions, while preventing the aircraft from being seen by personnel on the ground. Further, there is a need for a visual system that is more effective at helping pilots in locating airstrips, personnel, and equipment on the ground. Additionally, there is a need for a visual system that reduces and minimizes bird strikes that occur when aircraft are operating in blackout configuration at night or dusky conditions. ² Bird Strike. 3 Aug. 2024. Retrieved 29 Aug. 2024. https://en.wikipedia.org/wiki/Bird_strike.

### SUMMARY

According to one embodiment, an ultraviolet strobe system for an aircraft having at least one infrared strobe system and a night vision device includes at least one ultraviolet strobe device and a controller connected to the at least one ultraviolet strobe device. The controller causes the at least one ultraviolet strobe device to coordinate with the at least one infrared strobe system to alternate between ultraviolet strobing and infrared strobing.

According to another embodiment, an aircraft has an ultraviolet strobe system, an infrared strobe system, and a night vision device. The ultraviolet strobe system includes at least one ultraviolet strobe device and a controller connected to the at least one ultraviolet strobe device and to the infrared strobe system. The controller causes the at least one ultraviolet strobe device to coordinate with the at least one infrared strobe system to alternate between ultraviolet strobing and infrared strobing.

UV light is electromagnetic radiation with a wavelength from roughly 10 nm (30 PHz) to 385 nm (750 THz), which is a shorter wavelength than that of visible light but longer than X-rays. UV radiation is present in sunlight and is also produced by electric arcs and specialized lights such as mercury-vapor lamps, tanning lamps, and black lights. Although the UV light lacks the energy to ionize atoms, long-wavelength ultraviolet radiation can influence chemical reactions, and causes many substances to glow or fluoresce. It is noted that electromagnetic radiation having a wavelength less than 385 nm is considered UV, and visibility with the naked eye generally ceases at wavelengths below 365 nm. That being said, electromagnetic radiation having a wavelength of 395 nm typically produces fluorescence in materials, although the light may be visible to the naked eye.

Ultraviolet (UV) light, for the purpose of the present system, generally means electromagnetic radiation with a wavelength from roughly 10 nm (30 PHz) to 385 nm (750 THz). However, embodiments of the present system may effectively utilize light further extending into the range of 385 nm to 445 nm, for non-limiting example from 315 nm to 400 nm, or may even utilize light within the range of 385 nm to 445 nm exclusively. Specifically, UV light producing sources such as LEDs or other devices sometimes produce light within a Gaussian spectral distribution of wavelengths, typically centered about a target wavelength. For non-limiting example, an LED designed to emit light between 385 nm and 400 nm in wavelength may still produce approximately thirty percent of its total light output at a wavelength of less than 365 nm. While pure UV light is considered to include light at wavelengths of no greater than 400 nm, and the range between 400 nm and 445 nm is considered “violet”, with 445 nm referred to as “getting into blue”, the range of electromagnetic radiation between 380 nm and 450 nm typically still includes some percentage of UV light at the lower end of the Gaussian spectral distribution. This is true even for high quality LEDs with a tight 445 nm spectrum by industry standards.

The present invention utilizes one or more UV strobes in conjunction with the IR strobe(s) and night vision equipment in order to better assist pilots in flying their aircraft in formation and in locating other aircraft under blackout conditions, while preventing the aircraft from being seen by personnel on the ground. The present invention further utilizes the one or more UV strobes in conjunction with the IR strobe(s) and night vision equipment in order to more effectively help pilots in locating airstrips, personnel, markers, and equipment on the ground. The present invention further utilizes the one or more UV strobes in conjunction with the IR strobe(s) and night vision equipment in order to reduce and minimize bird strikes that occur when aircraft are operating in blackout configuration at night or dusky condition.

These purposes are accomplished by the use of both IR and UV strobes, which may be configured such that individual strobe pulses alternate between IR and UV light, or such that sets or patterns of strobe pulses alternate between IR and UV light. In so doing, no visible light is used, so that the aircraft remains dark to the unaided eye. In still other embodiments, the pilot of the aircraft may be enabled to decide to use IR or UV or both IR and UV as needed. The UV strobes may be controlled by the same controllers and/or circuits as the IR strobes or may be controlled by similar controllers and/or circuits that are in communication with those controlling the IR strobes. Moreover, the length of the pulses of UV light may be adjustable by the pilot, as may the length of the separations between the pulses. Similarly, the number of pulses of UV light may be changed by the pilot.

With respect to the use of the one or more UV strobes in conjunction with the IR strobe(s) and night vision equipment in order to better assist pilots in flying their aircraft in formation and in locating other aircraft under blackout conditions, the aforementioned weakly illuminated green formation lights may in the present invention be eliminated in favor of phosphorescent markers that phosphor in response to the UV strobes. The phosphorescent markers may be phosphorescent painted markers or phosphorescent marker devices. In addition to eliminating the weight, complexity, cost, power consumption, and maintenance of the formation lights, the invisibility of the UV light to the naked eye further protects the aircraft bearing the phosphorescent markers from observation from the ground and further protects the night vision of the pilots.

Specifically, as soon as a human eye acquires a target, it re-adjusts its exposure by adjusting the iris, which adjusts the size of the pupil. Initial dark adaptation takes place in approximately four seconds of profound, uninterrupted darkness. Full adaptation through adjustments in retinal rod photoreceptors is 80% complete in thirty minutes. The process is nonlinear and multifaceted, so an interruption by light exposure requires restarting the dark adaptation process over again. The human eye can detect a luminance from 10−6 cd/m², or one millionth of a candela per square meter to 108 cd/m2 or one hundred million candelas per square meter. At the low end of the range is the absolute threshold of vision for a steady light across a wide field of view, about 10−6 cd/m2. The upper end of the range is given in terms of normal visual performance as 108 cd/m2.³

A bright white strobe, therefore, can reset the dark adaptation process so that another twenty or thirty minutes are required to regain night vision. Conversely, markers that phosphor in response to a UV strobe only takes 4/100 of a second to register with the human eye. Moreover, the phosphorescent properties of the phosphorescent markers may be chosen so that the night vision equipment that allows the pilots to see IR light also admits the reflectance wavelengths produced by the phosphorescent markers. Additionally, the phosphorescent markers may even be configured to absorb UV light and to phosphor in IR wavelengths and may be configured to reflect light only in the direction of the UV strobe. In this configuration, the phosphorescent markers may be expanded to convey information beyond the three key visual points used to locate the aircraft. For non-limiting example, further identifying or status ³ Human Eye. 24 Aug. 2024. Retrieved 4 Sep. 2024. https://en.wikipedia.org/wiki/Human_eye. information may be conveyed using phosphorescent paint that reflects light only in the direction of the UV strobe.

Similarly, with respect to helping pilots in locating airstrips, personnel, markers, and equipment on the ground, the one or more UV strobes of the present invention can illuminate markings, devices, personnel, and/or equipment that are provided with reflectance material such as UV reflective paint or apparel. The UV strobes thereby cause the reflectance material of the personnel and/or objects to convert the UV light to a visible wavelength of light which radiates from the object, without ever illuminating the aircraft. The object may, for non-limiting example, be apparel such as a safety vest or other garment, which may in turn be part of OSHA/EPA Level A, B, C, or D civilian Personal Protective Equipment (PPE), NFPA Class 1, 2, 3, or 4 PPE, MOPP Ready, 0, 1, 2, 3, or 4, and/or ANSI/ISEA 107-2020 Type O, R, P, and/or Performance Class 1, 2, or 3, or Supplemental Class E PPE. The object may, for further non-limiting example, be markers or devices such as cones, symbols, or signs.

As with the formation lights, only a short duration of strobe illumination is required for the pilots' eyes to register the reflected light of the UV reflective material of the markings, personnel, and/or equipment. Moreover, the phosphorescent properties of the phosphorescent markers may again be chosen so that the night vision equipment that allows the pilots to see IR light also admits the reflectance wavelengths produced by the phosphorescent markers, which reflectance wavelengths may or may not include IR wavelengths. Additionally, the phosphorescent markers may again be configured to absorb UV light and to phosphor in IR wavelengths and/or may be configured to reflect light only in the direction of the UV strobe.

In this way, the present invention works with the night vision devices to allow the pilots to see UV activated markings, personnel, and equipment through the IR illumination. By using UV reflected light, pilots of combat aircraft are enabled to navigate to a landing area and observe markings on the landing field such as landing zones, edge markings, cones, and off-field areas. Pilots are further enabled to see personnel on the ground without turning on visible lights. Rather than having to carry heavy awkward IR strobes, ground personnel can carry and use lightweight simple UV reflective phosphorescent markers for this purpose. The present invention UV strobe capabilities may therefore be an optionally used system for take-off, landing, and field operations where the UV could be turned on during the off cycle of IR strobing and illuminate a phosphor target like a vest. As noted previously, this means field or ground personnel do not need to carry a powered IR strobe unit to be seen but only a lower cost material that will phosphor when activated.

With regards to the use of the present invention to reduce and minimize bird strikes that occur when aircraft are operating in blackout configuration at night or dusky conditions, certain birds have a very high density of receptors in their eyes and other adaptations that maximize visual acuity. The placement of their eyes gives them good binocular vision enabling accurate judgement of distances. There are two sorts of light receptors in a bird's eye, rods and cones. Rods are better for night vision because they are sensitive to small quantities of light. Cones detect specific wavelengths of light which, for some birds, extend to the ultraviolet (UV) range, making them UV-sensitive.⁴ In this way, the UV strobes of the present invention alert birds in the area to the presence of the aircraft without compromising the aircraft's invisibility to the eyes of observers on the ground, thereby reducing bird strikes and improving safety. ⁴ Bird Vision. 18 Aug. 2024. Retrieved 30 Aug. 2024. https://en.wikipedia.org/wiki/Bird_vision.

The ultraviolet LED strobes of the present invention may include one or more ultraviolet LEDs, which emit light in the ultraviolet wavelength range. The LED chips may be of various types, such as InGaN, AlGaN, or AllnGaN, depending on the desired wavelength range. The LEDs may be arranged in a single array or in multiple arrays, depending on the application. Additionally, ramp-up and ramp-down periods may be provided by the microcontroller, during which different patterns of UV pulses may be utilized, in order to facilitate operation and longevity of the LEDs. In this way, and by virtue of the pulsed operation of the UV LEDs, overall electrical power consumed by embodiments of the present invention may be reduced by 40 to 50 percent, and operational life of the LEDs may be doubled or tripled over continuously powered LED arrangements.

### DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a right hand side view of an aircraft having an embodiment of an IR/UV strobe device; and

FIG. 2 is a view of an aircraft having an embodiment of an IR/UV strobe device in context.

Corresponding reference characters indicate corresponding parts throughout the several views. The exemplifications set out herein illustrate embodiments of the invention and such exemplification are not to be construed as limiting the scope of the invention in any manner.

### DETAILED DESCRIPTION

The following detailed description and appended drawing describe and illustrate various exemplary embodiments of the invention. The description and drawings serve to enable one skilled in the art to make and use the invention and are not intended to limit the scope of the invention in any manner. In respect of any methods disclosed and illustrated, the steps presented are exemplary in nature, and thus, the order of the steps is not necessary or critical.

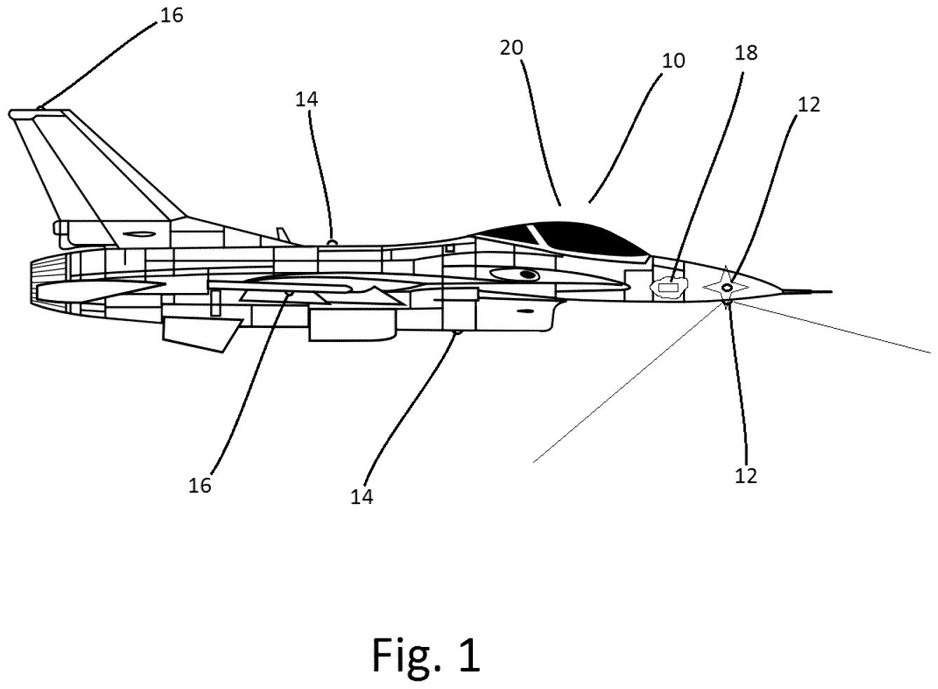

Referring now to the drawings, and more particularly to FIG. 1, a combat aircraft 10 is shown. The combat aircraft is provided with one or more UV strobes 12, as well as one or more IR strobes 14 and one or more fluorescent markers 16 that are configured to fluoresce in the presence of UV light. The one or more UV strobes 12 illuminate the one or more fluorescent markers 16 when in operation, causing them to fluoresce in wavelengths that are visible to pilots of other combat aircraft, which wavelengths may be visible to the other pilots only using night vision equipment 20, or otherwise. The one or more UV strobes 12 are controlled by one or more controllers 18, which may also serve to control the one or more IR strobes 14.

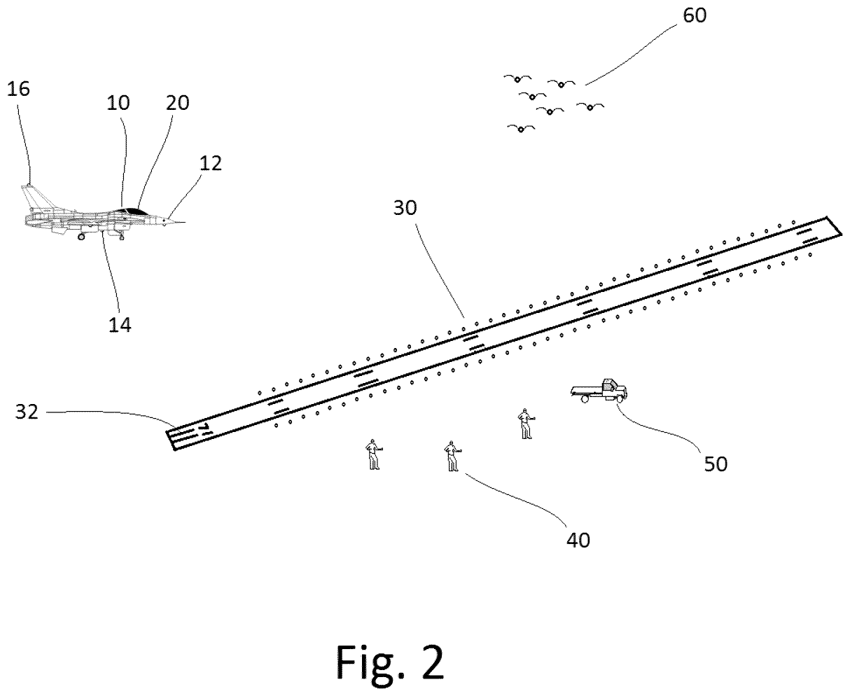

Referring now to FIG. 2, there is shown another embodiment of a combat aircraft 10 having one or more UV strobes 12, one or more IR strobes 14, one or more fluorescent markers 16, and night vision equipment 20. An airstrip 30 may be provided with field markings 32 that fluoresce in the presence of the UV strobes 12, thereby assisting pilots with takeoffs and landings. Personnel 40 and equipment 50 may be provided with UV reflective material so that they are visible to pilots without having to use visible light or ground based IR strobes. Additionally, birds 60 are able to see and react to the UV strobes 12, in order to reduce bird strikes and increase safety.

While illustrative arrangements of the invention have been described with respect to at least one embodiment, the arrangements and methods can be further modified within the spirit and scope of this disclosure, as demonstrated previously. This application is therefore intended to cover any variations, uses, or adaptations of the arrangement and method using its general principles. Further, this application is intended to cover such departures from the present disclosure as come within known or customary practice in the art to which the disclosure pertains and which fall within the limits of the appended claims.

What is claimed is:

1. An ultraviolet strobe system for an aircraft having an infrared strobe system and a night vision device comprising:
at least one ultraviolet strobe device; and
a controller connected to the at least one ultraviolet strobe device;
wherein the controller causes the at least one ultraviolet strobe device to coordinate with the at least one infrared strobe system to alternate between ultraviolet strobing and infrared strobing.

2. The ultraviolet strobe system of claim 1, wherein:
the controller is further connected to the at least one infrared strobe system.

3. The ultraviolet strobe system of claim 1, wherein:
the controller further causes the at least one ultraviolet strobe device to coordinate with the at least one infrared strobe system to alternate between sets or patterns of ultraviolet strobing and infrared strobing.

4. The ultraviolet strobe system of claim 3, wherein:
the controller further providing a pilot of the aircraft the ability to adjust at least one of:
the length of strobe pulses of ultraviolet light, the length of the separations between strobe pulses of ultraviolet light and infrared light, and
the number of strobe pulses of ultraviolet light.

5. The ultraviolet strobe system of claim 1, further comprising:
at least one phosphorescent marker affixed to the aircraft that phosphors in response to an ultraviolet strobe device of another ultraviolet strobe system installed on another aircraft.

6. The ultraviolet strobe system of claim 5, wherein:
the at least one phosphorescent marker phosphors in a wavelength that is visible using another night vision device on the other aircraft.

7. The ultraviolet strobe system of claim 6, wherein:
the at least one phosphorescent marker phosphors and directs the light produced substantially back in the direction of the ultraviolet strobe device of the other ultraviolet strobe system.

8. The ultraviolet strobe system of claim 5, wherein:
the controller illuminates the ultraviolet strobe for a duration of time of each strobe event no longer than a duration of time necessary for a human eye to register the illumination.

9. The ultraviolet strobe system of claim 1, wherein:
the frequency and wavelength of the ultraviolet light produced by the at least one ultraviolet strobe device being chosen to maximize visibility of the ultraviolet light strobe to birds while remaining outside of the visual perception of personnel.

10. The ultraviolet strobe system of claim 1, further comprising:
at least one of ground based markings, devices, personnel apparel, and/or equipment provided with markings that phosphor in response to the ultraviolet strobe device.

11. The ultraviolet strobe system of claim 10, wherein:
the markings phosphor in a wavelength that is visible using the night vision device.

12. The ultraviolet strobe system of claim 10, wherein:
the markings phosphor and direct the light produced substantially back in the direction of the ultraviolet strobe device.

13. The ultraviolet strobe system of claim 1, wherein:
the at least one ultraviolet strobe device further comprises at least one ultraviolet LED.

14. The ultraviolet strobe system of claim 13, wherein:
the at least one ultraviolet LED being at least one of:
an InGaN, AlGaN, or AllnGaN LED, and
arranged in a single array or in multiple arrays.

15. An aircraft having an ultraviolet strobe system, an infrared strobe system, and a night vision device, the ultraviolet strobe system comprising:
at least one ultraviolet strobe device; and
a controller connected to the at least one ultraviolet strobe device and to the infrared strobe system;
wherein the controller causes the at least one ultraviolet strobe device to coordinate with the at least one infrared strobe system to alternate between ultraviolet strobing and infrared strobing.

16. The aircraft of claim 15, wherein:
the controller further causes the at least one ultraviolet strobe device to coordinate with the at least one infrared strobe system to alternate between sets or patterns of ultraviolet strobing and infrared strobing.

17. The aircraft of claim 15, further comprising:
at least one phosphorescent marker affixed to the aircraft that phosphors in response to an ultraviolet strobe device of another ultraviolet strobe system installed on another aircraft in a wavelength that is visible using another night vision device on the other aircraft.

18. The aircraft of claim 17, wherein:
the markings phosphor and direct the light produced substantially back in the direction of the ultraviolet strobe device of the other aircraft.

19. The aircraft of claim 17, wherein:
the controller illuminates the ultraviolet strobe for a duration of time of each strobe event no longer than a duration of time necessary for a human eye to register the illumination.

20. The aircraft of claim 15, wherein:
the frequency and wavelength of the ultraviolet light produced by the at least one ultraviolet strobe device being chosen to maximize visibility of the ultraviolet light strobe to birds while remaining outside of the visual perception of personnel.
